(19) United States
(12) Patent Application Publication
(10) Pub. No.: US 2007/0012154 A1
(43) Pub. Date: Jan. 18, 2007

(54) Decorative case

(75) Inventor: Ching-Tien Tsai, Er Lin Town (TW)

Correspondence Address: NIKOLAI & MERSEREAU, P.A., 900 SECOND AVENUE SOUTH, SUITE 820, MINNEAPOLIS, MN, 55402, US

(73) Assignee: HSINN INN ENTERPRISE CO., LTD., Changhua Hsien (TW)

(21) Appl. No.: 11/183,616

(22) Filed: Jul. 18, 2005

(51) Int. Cl. G10F 1/06

(52) U.S. Cl. 84/95.1

(57) ABSTRACT

A decorative case includes a box, a link, a gear transmission system, and a rotation disk. The rotation disk is rotated by operation of a motor, so that the ornament is rotated successively and automatically during a long period of time, thereby facilitating rotation of the ornament, and thereby saving the manual work. In addition, the light emitting members disposed in the ornament light continuously and blink intermittently, thereby enhancing the aesthetic quality of the ornament. Thus, the decorative case is rotated successively and can emit light outward simultaneously.

### BACKGROUND OF THE INVENTION

1. Field of the Invention

The present invention relates to a decorative case, and more particularly to a decorative case that is rotated successively and can emit light outward simultaneously.

2. Description of the Related Art

A conventional decorative case comprises a housing, a rotary disk rotatably mounted on the housing, and an ornament mounted on the rotary disk to rotate therewith. The rotary disk is usually rotated mechanically in a wind-up manner, so that the rotary disk is only rotated during a short period of time, and movement of the ornament will stop when the rotary disk stops rotating, thereby greatly decreasing the amusement effect of the conventional decorative case. In addition, the ornament cannot emit light, thereby greatly limiting the versatility of the conventional decorative case.

### SUMMARY OF THE INVENTION

In accordance with the present invention, there is provided a decorative case, comprising a box, a link pivotally mounted in the box, a gear transmission system mounted in the box and having a drive gear rotatably mounted in the box and a drive shaft mounted on the drive gear to rotate therewith and pivotally connected to a first end of the link to pivot the link, and a rotation disk rotatably mounted on the box and having a driven shaft extended through the box and connected to a second end of the link to move therewith so that the rotation disk is rotatable by pivot of the link.

The primary objective of the present invention is to provide a decorative case that is rotated successively and can emit light outward simultaneously.

Another objective of the present invention is to provide a decorative case, wherein the rotation disk is rotated by operation of the motor, so that the ornament is rotated successively and automatically during a long period of time, thereby facilitating rotation of the ornament, and thereby saving the manual work.

A further objective of the present invention is to provide a decorative case, wherein the light emitting members disposed in the ornament light continuously and blink intermittently, thereby enhancing the aesthetic quality of the ornament.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a decorative case in accordance with the preferred embodiment of the present invention;

FIG. 2 is an exploded perspective view of the decorative case as shown in FIG. 1;

FIG. 3 is a plan cross-sectional view of the decorative case as shown in FIG. 1;

FIG. 4 is a perspective view of the decorative case in accordance with the preferred embodiment of the present invention; and

FIG. 5 is a perspective view of a decorative case in accordance with another preferred embodiment of the present invention.

### DETAILED DESCRIPTION OF THE INVENTION

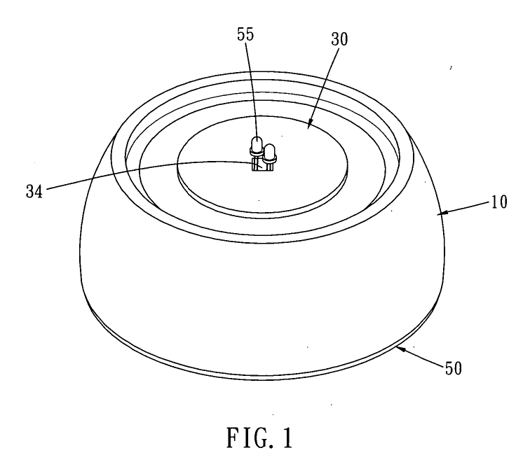

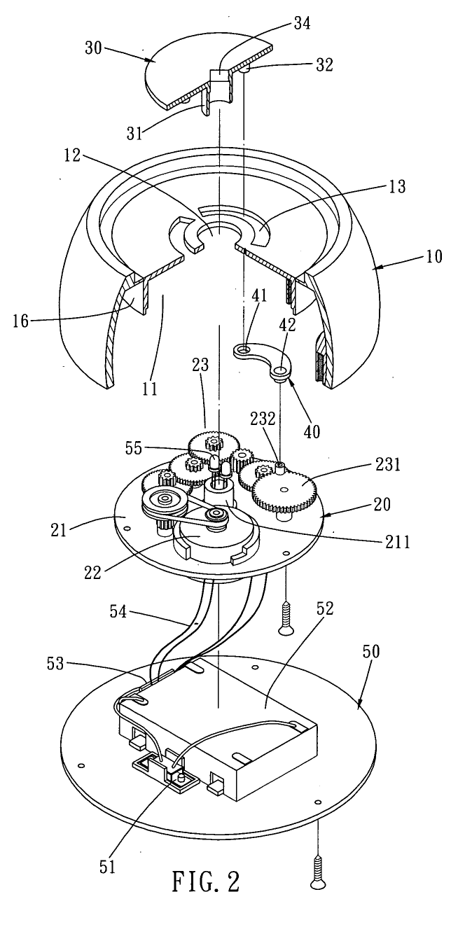

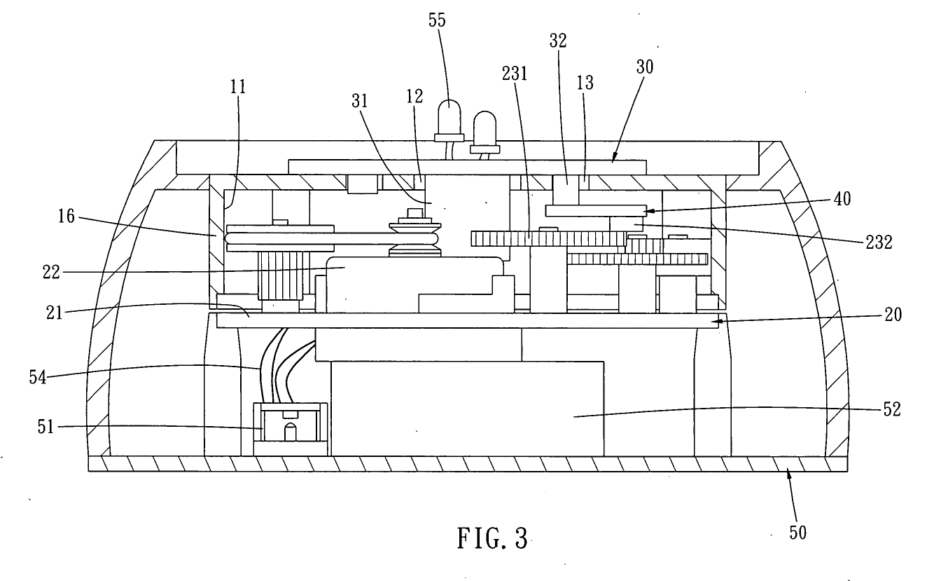

Referring to the drawings and initially to FIGS. 1-3, a decorative case in accordance with the preferred embodiment of the present invention comprises a box 10, a link 40 pivotally mounted in the box 10, a gear transmission system 23 mounted in the box 10 and having a drive gear 231 rotatably mounted in the box 10 and a drive shaft 232 mounted on the drive gear 231 to rotate therewith and pivotally connected to a first end of the link 40 to pivot the link 40, and a rotation disk 30 rotatably mounted on the box 10 and having a driven shaft 32 extended through the box 10 and connected to a second end of the link 40 to move therewith so that the rotation disk 30 is rotatable by pivot of the link 40.

The box 10 has an inside having an upper portion formed with an annular chamber 11 for mounting the gear transmission system 23 and the link 40. The chamber 11 of the box 10 is defined by an annular wall 16. The box 10 has a top face having a central portion formed with a circular hole 12 and a periphery formed with a substantially arc-shaped guide slot 13.

The decorative case further comprises a transmission mechanism 20 mounted in the chamber 11 of the box 10 and including a motor 22 connected to the gear transmission system 23 to drive and rotate the drive gear 231 of the gear transmission system 23, and a support disk 21 secured to the box 10 to support the motor 22 and the gear transmission system 23. The support disk 21 of the transmission mechanism 20 is secured to a bottom of the annular wall 16 of the box 10. The support disk 21 of the transmission mechanism 20 has a central portion formed with a protruding hollow support post 211. The drive shaft 232 of the gear transmission system 23 is located on a periphery of the drive gear 231 so that the drive shaft 232 is rotated with the drive gear 231 eccentrically.

The rotation disk 30 has a central portion formed with a protruding hollow rotation shaft 31 extended through the circular hole 12 of the box 10 and rotatably mounted on the support post 211 of the support disk 21. The driven shaft 32 is located on a periphery of the rotation disk 30 and slidably mounted in the guide slot 13 of the box 10.

The link 40 is substantially arc-shaped. The first end of the link 40 has a first pivot hole 42 mounted on the drive shaft 232 of the gear transmission system 23, and the second end of the link 40 has a second pivot hole 41 mounted on the driven shaft 32 of the rotation disk 30.

The decorative case further comprises a plurality of light emitting members 55 mounted in the support post 211 of the support disk 21 and partially protruded outward from the rotation disk 30, a bottom cover 50 secured to a bottom of the box 10, a battery housing 52 mounted on the bottom cover 50 for receiving at least one battery (not shown), a circuit board 53 mounted on the bottom cover 50 and electrically connected to the battery housing 52, and a control switch 51 mounted on the bottom cover 50 and connected between the circuit board 53 and the battery housing 52 to control operation of the circuit board 53. The circuit board 53 is electrically connected to the motor 22 of the transmission mechanism 20 and the light emitting members 55 by electric wires 54. The rotation disk 30 has a passage 34 to allow passage of the light emitting members 55.

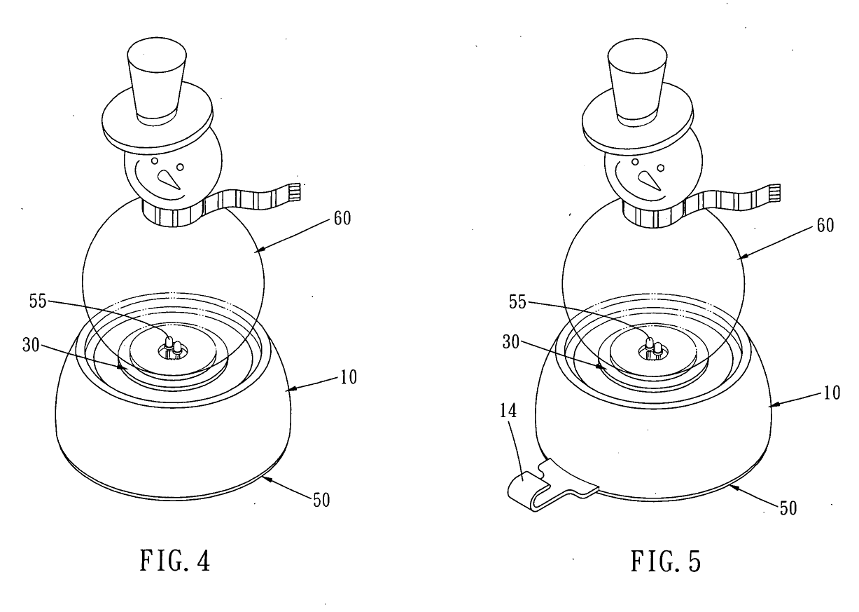

Referring to FIGS. 1-4, an ornament 60 is secured on the rotation disk 30 to rotate therewith, and the light emitting members 55 are disposed in the ornament 60. When the control switch 51 is turned on, the light emitting members 55 light and blink, while the motor 22 of the transmission mechanism 20 is operated to drive the drive gear 231 which rotates the drive shaft 232 which pivots the link 40 which drives the driven shaft 32 to rotate the rotation disk 30 so as to rotate the ornament 60. At this time, the driven shaft 32 of the rotation disk 30 is limited by the guide slot 13 of the box 10, so that the rotation disk 30 is rotated smoothly and stably.

As shown in FIG. 5, the decorative case further comprises a hanging hook 14 mounted on a periphery of the box 10 for hanging smaller ornamental items (not shown).

Accordingly, the rotation disk 30 is rotated by operation of the motor 22, so that the ornament 60 is rotated successively and automatically during a long period of time, thereby facilitating rotation of the ornament 60, and thereby saving the manual work. In addition, the light emitting members 55 disposed in the ornament 60 light continuously and blink intermittently, thereby enhancing the aesthetic quality of the ornament 60.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A decorative case, comprising:
a box;
a link pivotally mounted in the box;
a gear transmission system mounted in the box and having a drive gear rotatably mounted in the box and a drive shaft mounted on the drive gear to rotate therewith and pivotally connected to a first end of the link to pivot the link;
a rotation disk rotatably mounted on the box and having a driven shaft extended through the box and connected to a second end of the link to move therewith so that the rotation disk is rotatable by pivot of the link.

2. The decorative case in accordance with claim 1, wherein the box has an inside having an upper portion formed with an annular chamber for mounting the gear transmission system and the link.

3. The decorative case in accordance with claim 2, wherein the chamber of the box is defined by an annular wall.

4. The decorative case in accordance with claim 2, further comprising a transmission mechanism mounted in the chamber of the box and including a motor connected to the gear transmission system to drive and rotate the drive gear of the gear transmission system.

5. The decorative case in accordance with claim 4, wherein the transmission mechanism further includes a support disk secured to the box to support the motor and the gear transmission system.

6. The decorative case in accordance with claim 5, wherein the chamber of the box is defined by an annular wall, and the support disk of the transmission mechanism is secured to a bottom of the annular wall of the box.

7. The decorative case in accordance with claim 1, wherein the drive shaft of the gear transmission system is located on a periphery of the drive gear so that the drive shaft is rotated with the drive gear eccentrically.

8. The decorative case in accordance with claim 1, wherein the box has a periphery formed with a substantially arc-shaped guide slot, and the driven shaft is located on a periphery of the rotation disk and slidably mounted in the guide slot of the box.

9. The decorative case in accordance with claim 5, wherein the box has a top face having a central portion formed with a circular hole, the support disk of the transmission mechanism has a central portion formed with a protruding hollow support post, and the rotation disk has a central portion formed with a protruding hollow rotation shaft extended through the circular hole of the box and rotatably mounted on the support post of the support disk.

10. The decorative case in accordance with claim 1, wherein the link is substantially arc-shaped.

11. The decorative case in accordance with claim 1, wherein the first end of the link has a first pivot hole mounted on the drive shaft of the gear transmission system, and the second end of the link has a second pivot hole mounted on the driven shaft of the rotation disk.

12. The decorative case in accordance with claim 9, further comprising a plurality of light emitting members mounted in the support post of the support disk and partially protruded outward from the rotation disk.

13. The decorative case in accordance with claim 12, further comprising a bottom cover secured to a bottom of the box, a battery housing mounted on the bottom cover for receiving at least one battery, a circuit board mounted on the bottom cover and electrically connected to the battery housing, and a control switch mounted on the bottom cover and connected between the circuit board and the battery housing to control operation of the circuit board.

14. The decorative case in accordance with claim 13, wherein the circuit board is electrically connected to the motor of the transmission mechanism and the light emitting members by electric wires.

15. The decorative case in accordance with claim 12, wherein the rotation disk has a passage to allow passage of the light emitting members.

16. The decorative case in accordance with claim 1, further comprising an ornament secured on the rotation disk to rotate therewith, wherein the light emitting members are disposed in the ornament.

17. The decorative case in accordance with claim 1, further comprising a hanging hook mounted on a periphery of the box.
